(19) United States
(12) Patent Application Publication
(10) Pub. No.: US 2014/0129926 A1
(43) Pub. Date: May 8, 2014

(54) METHOD FOR DEVELOPING A WEB PORTAL, METHOD FOR IMPLEMENTING THE SAME, AND CORRESPONDING COMPUTER PROGRAM PRODUCT

(71) Applicants: Thomas Landais, Houilles (FR); Bertrand Desson, Clamart (FR)

(72) Inventors: Thomas Landais, Houilles (FR); Bertrand Desson, Clamart (FR)

(21) Appl. No.: 14/125,078

(22) PCT Filed: Jun. 8, 2012
(86) PCT No.: PCT/EP2012/060872

§ 371 Date: Dec. 9, 2013

(30) Foreign Application Priority Data
Jun. 10, 2011 (FR) 1155131

(51) Int. Cl. G06F 17/22

(52) U.S. Cl. CPC G06F 17/2247
USPC 715/234

(57) ABSTRACT

The present invention relates to a method for developing a Web portal, the Web portal being implemented locally by a browser (11) of a device (1), the method being characterized in that it comprises: a step of configuring the portal, according to which an interface (21) of a computer (2) enables the selection and organization of a set (E1) of functionality modules (211) and/or event-managing modules (212) forming the Web portal, a code (42) stored on a server (3) being associated with each of said modules (211, 212); a compiling step, according to which a processor (22) of the computer (2) generates, from the set (E1), a file (E3) of instructions that can be implemented by the browser (11); and a downloading step, according to which the processor (22) downloads the file (E3) of instructions and a group (E2) of codes (42) associated with the modules (211, 212) to the device (1). The invention further relates to a system for implementing the method and to a corresponding computer program product.

### GENERAL TECHNICAL FIELD

The present invention relates to a process for development of a web portal, the web portal being executed locally by a browser of a device.

It also relates to a system for executing the process and a corresponding computer program product.

### PRIOR ART

Set top boxes in the telecommunications field are known.

A set top box is an electronic device connected to a television screen, which converts audiovisual signals (sometimes coded and usually transmitted by coaxial cable, by telephone line or via satellite) in a form allowing them to be correctly received and processed by the television screen. This makes it necessary to use a set top box to get access to channels or television programs which can be available in certain conditions only set by a diffuser or a distributor.

In general, operation of the set top box is managed by way of a portal, displayed at least in part on the television screen, and especially allowing interaction with a user of the set top box.

Known portals of known set top boxes use web technology, specifically technology based on the use of hypertexts and hypermedia data (that is, an extension of hypertext to multimedia data, for including links between text, visual and sound elements).

Web technology especially allows information search in a menu tree, the access to this information and its display by way of a web browser, that is, software capable of running hypertext and hypermedia resources.

A known portal for a known set top box is presented as a web site, where data accessible by the web browser are stored, and which proposes especially links between information and functionalities.

The portal therefore comprises an entry point (a welcome page) and a set of modules which interact with each other and/or respond to external events.

A known portal is generally created by using known web programming languages, such as for example
HTML language (HyperText Markup Language), that is, a text markup language, which enables creation of hypertext documents displayed by the web browser;
Javascript language, that is, a script-editing language (a script is a program constituted by a suite of commands exempting users from inputting them, and performing a particular function or contributing to execution of another program), the Javascript editing language being especially intended for non-specialist users, and for integrating pre-programmed instructions into the construction of a web document;
PHP language (PHP Hypertext Preprocessor);
cascading style sheets (CSS), that is, text files which contain a list of HTML markers, as well as the formatting associated to each, and which precisely define the font, size, color and arrangement of elements of a web page in relation to each other . . . .

In practice, if a diffuser or a distributor wants to develop a portal for a set top box, he must set up an inhouse team dedicated to web development, or outsource the web development if he does not have this type of knowledge or if he does not want to develop it inhouse.

In addition, development of new functionality by a developer requires creation of test pages for verifying proper operation of the portal. Once development is complete, the integrator must also create a test page and the same applies for the validation part. In this way, each later evolution of the portal needs an extra integration step and an additional validation step, which are not always easy and which consequently require time.

Similarly, bug correction in the portal cannot be shared with other portals, and a correction must be made to each bug of each portal.

### PRESENTATION OF THE INVENTION

The invention proposes eliminating at least one of these disadvantages, by making the development of portals easier.

For this purpose, a process for development of a web portal is proposed according to the invention, the web portal being implemented locally by a device browser, the process being characterised in that it comprises
a configuration step of the portal, according to which an interface of a computer enables selection and organisation of a set of functionality modules and/or of event-managing modules forming the web portal, a code stored on a server being associated to each of said modules;
a compilation step, according to which a processor of the computer generates, from the set, an instruction file which can be run by the browser; and
a downloading step, according to which the processor downloads the instruction file and a group of codes associated to the modules on the device.

The invention is advantageously completed by the following characteristics, taken individually or in any one of their technically possible combinations:
selection of the functionality modules and/or of the event-managing modules is made from a library of modules;
the processor generates the instruction file by means of the server comprising a PHP module, the file being in web-oriented format using W3C technologies, preferably HTML, JavaScript, CSS, XML, XSLT or CGI;
each module is constructed under the same standard structure;
the instruction file comprises instructions according to which the events are managed by a stack of event-managing modules or functionality modules; and
the process further comprises a test step of the instruction file before the downloading step.

The invention also relates to a system for executing the process, and a corresponding computer program product.

The invention has numerous advantages.

It allows a diffuser or a distributor to develop a portal for example for a set top box without setting up any inhouse team dedicated to web development, or outsourcing this web development. The invention in fact allows total detachment of software and web programming language aspects, and therefore allows any user to create a portal without having web development knowledge. The invention especially rapidly modifies the content of a portal without the need for web development knowledge.

The invention allows to develop a portal from already constructed software bricks, which pools the developments of functionalities, bug corrections, and easily adds new functionalities.

The invention especially pools development between developers, integrators, and checkers, especially with respect to test pages.

The invention allows additions, deletions, and modifications to the elements constituting a portal, dynamically, which for example allows rapid testing of different options for functionalities.

A portal developed by a process according to the invention requires no PHP server to run.

It also exhibits gains in display performance.

### PRESENTATION OF FIGURES

Other characteristics, aims and advantages of the invention will emerge from the following description which is purely illustrative and non-limiting and which must be viewed in reference to the attached diagrams, in which:

FIG. 1 schematically illustrates a possible embodiment of a system according to the invention;

FIG. 2 schematically illustrates possible implementation of a process according to the invention;

FIG. 3 schematically illustrates a possible structure of a database of a server of a system according to the invention;

FIG. 4 schematically illustrates a possible structure of a directory containing a code source for a portal;

FIGS. 5 to 10 schematically illustrate possible forms of an interface of a computer of a system according to the invention for development of a portal;

FIG. 11 schematically illustrates a step for generation of an instruction file from a set of modules and codes;

FIG. 12 schematically illustrates possible event management on a device of a system according to the invention; and

FIG. 13 schematically illustrates a possible form of an interface of a computer of a system according to the invention, for the creation of a module;

Throughout the figures, similar elements bear identical reference numerals.

### DETAILED DESCRIPTION

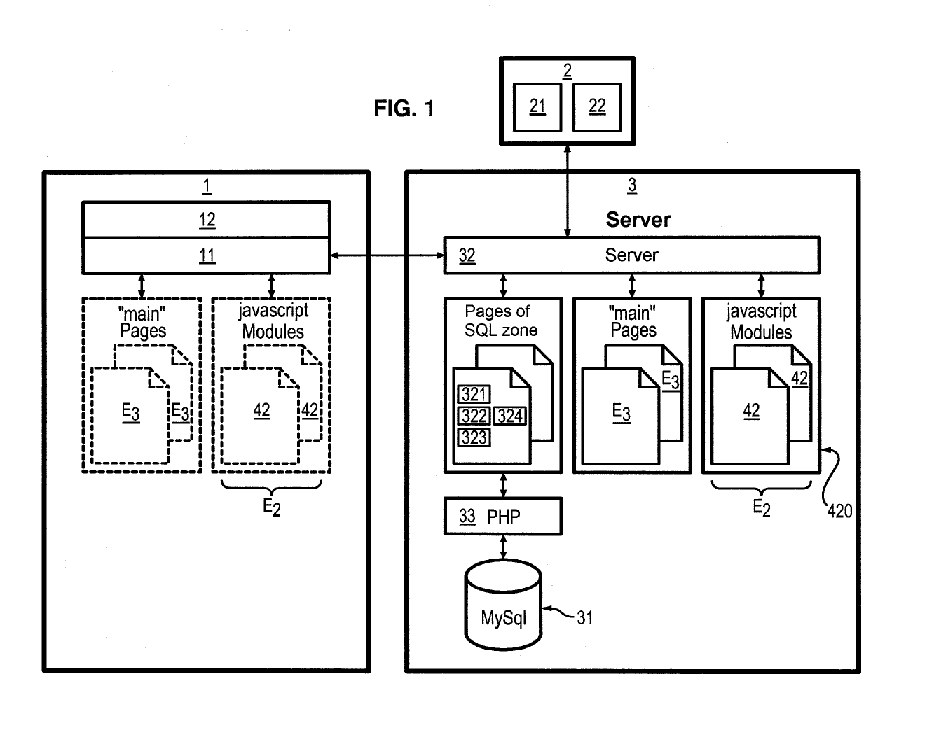

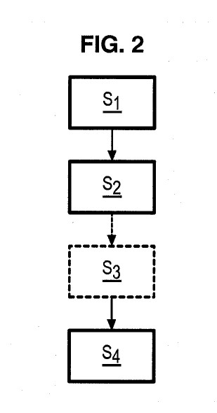

FIGS. 1 and 2 schematically illustrate a possible process according to the invention executed on a possible system according to the invention, the system comprising a device 1, a computer 2 and a server 3.

A possible process for development of a web portal mainly comprises
a configuration step S1 of the portal,
a compilation step S2, and
a downloading step S4 of an instruction file and a group of codes on the device 1, the device comprising a browser using web technology and capable of running the instruction file and the group of codes.

In fact, the web portal is intended to be used locally by the web browser 11 of the device 1 when the device 1 is as a normal operation.

The device 1 can be any type, such as for example a set top box (STB), a computer, a gateway, a smart meter, or any other onboard system having a browser.

The device 1 comprises especially an interface 12.

The interface 12 of the device 1 can comprise a monitor and/or a series of pilot lights and/or a keypad and/or a mouse and/or a remote control (comprising for example a numeric keypad and/or colored keys, with colors red, green, yellow and blue for example).

The device 1 is autonomous in the sense that it is not connected, as a normal operation, to a remote server of server 3 type. For example, when the device 1 is a set top box, as a normal operation it is connected to a television screen and converts audiovisual signals (sometimes coded and usually transmitted via coaxial cable, telephone line or via satellite) in a form allowing them to be correctly received and processed by the television screen.

The server 3 of the system is equipped with
a server 32, using web technology, preferably http (HyperText Transfer Protocol),
a 33 PHP module (PHP: Hypertext Preprocessor), and
a database 31 (of “MySQL” type for example).

The computer 2 conventionally comprises an interface 21 and a processor 22.

The processor 22 comprises all the conventional means of memory, communication and calculation for executing the process according to the invention, and is therefore not explained in detail in the following present description.

The interface 21 comprises a monitor and/or forms which can be displayed on the monitor (and described in more detail throughout the present description) and/or a keypad and/or a mouse and/or a remote control of device 1.

During step S1, the interface 21 of the computer 2 enables selection and organisation of a set E1 forming the web portal and constituted by
functionality modules 211, and/or
event-managing modules 212
   wanted by a user for the portal.

The set E1 corresponds to a skeleton of the preferred web portal on the device 1, and the modules 211 and 212 correspond to actions executable especially via the browser 11 of the device 1.

The difference between a module 211 and a module 212 is being explained here.

A functionality module 211 is executed by the browser 11 when a start function is called by the browser 11. It is also possible for a module 211 to be executed via another module 211; in this case, the module calling execution of the other module is a module of “menu” type (such as the principal menu of the portal for example).

Non-limiting examples of modules 211 are: information pages on the device 1 (display of serial number, . . . ), configuration pages of audio options, . . . .

An event-managing module 212 is executed by the browser 11 when at least one given event appears. The modules 212 are treated in more detail throughout the present description, but it is specified here that an event is for example pressure of a key on the remote control of the interface 12 of the device 1, the extraction of an electronic card of the device 1 or the arrival of a new signal at the level of the device 1. A module 212 is not accessible via the menu, as is management of sound volume for example.

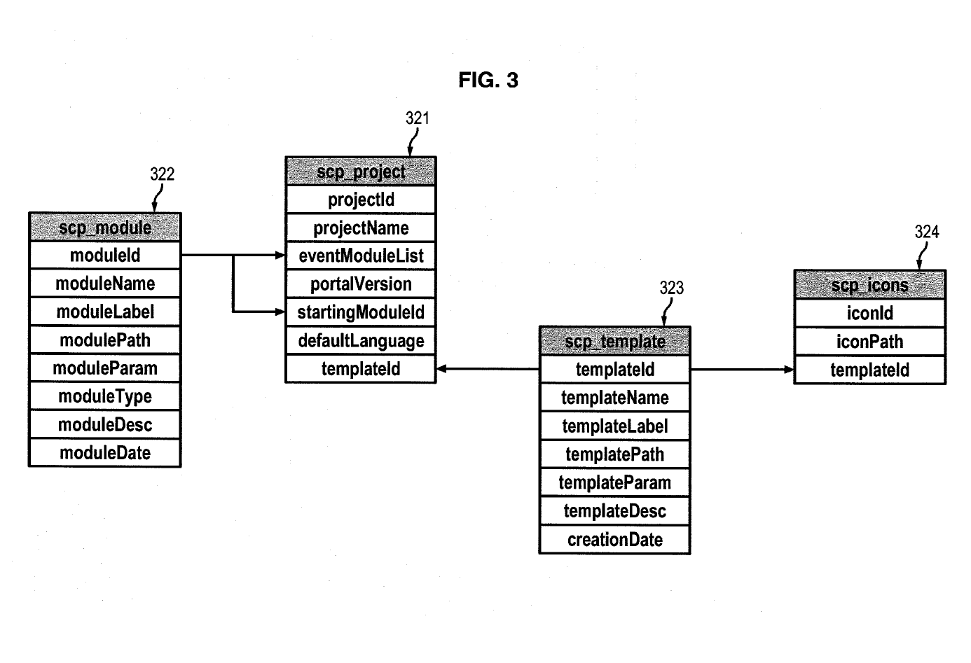

In connection with the modules 211 and 212, the database 31 of the server 3 stores tables 321, 322, 323 and 324 illustrated in FIG. 3.

Each table 321, called for example scp_project, contains the overall information for a given portal project.

Some of the information is not parametrable and therefore has exclusively inhouse usage, whereas other information parameters each portal project.

The information can be input by a user by way of forms of the interface 21, as described throughout the present description.

Each table 321 comprises
an identifier of the project (projectId)
a name of the project (projectName)
a version of the portal (portalVersion)
a language of the portal (defaultLanguage).

Table 321 optionally includes a module 212 in the project. It comprises a line (eventModuleList) which contains the list of modules which are triggered only by events.

Table 321 optionally includes a module 211 in the project. It comprises a line (startingModuleId) for specifying the first module which will be launched in execution of the portal, and which could also call other modules.

It also contains a line (templateId) for indicating which template is utilised by the project.

The templates are modules which have additional functions relative to the other modules 211 or 212. Each template is combined into one table 323, for example called scp_template, which saves the different information of the template, such as its identifier (Id), its name (name), its access path (path), as well its parameters (param).

Each table 322, called for example scp_module, contains the information for producing and configuring the modules 211 or 212. As will be explained in more detail hereinbelow, each module 211 or 212 has an identifier (moduleld) and a certain number of parameters. Each module 211 or 212 is indexed in the database 31.

Each table 324, for example called scp_icons, simplifies use of icons within the database 31 by associating with the access path of the icon an identifier which could then be used in the parameters of modules 211 or 212. The icons are also associated to a template.

The base 31 also contains links to source codes 42, contained in files 420, each code 42 corresponding to a module 211 or 212.

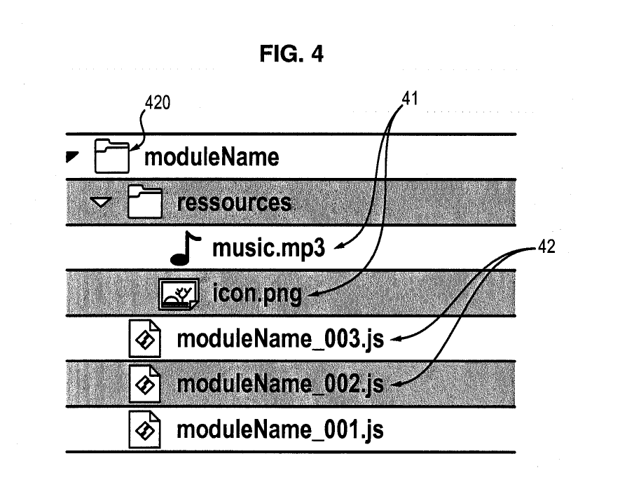

For this purpose, as shown in FIG. 4, each code 42 is copied to a specific directory 420 of the server 3. The directory 420 is called by the name of the module 211 or 212.

The code 42 is copied in the form of a source file of the module 211 or 212, in Javascript or HTML format.

Each code file 42 is called by the name of the module 211 or 212, preferably followed by the version number of the module, for example of three characters. The user can therefore select a particular version of the module 211 or 212 as a function of the architecture of the device 1 (archi V1 or archi V2 for example). Of course, the specific directory 420 can contain other directories, for specific resources 41 of the module (icons, images, sounds, etc.).

A possible example for conducting step S1 is given hereinbelow.

During step S1, the user indicates an identifier of a portal project in the interface 21.

For this purpose, the interface 21 comprises an HTML form known to the expert.

HTML forms utilise known HTML functions executed by the computer 2, such as for example the following function which recovers an object of “window”

UI_getNewWindow (width, height, opacity)

In conventional terms, a window comprises three separate zones:
a title zone,
content, and
a footer.

The HTML functions hereinbelow complete each of these zones.

window.updateTitle(title);
window.updateContent(content) ;
window.updateFooter(footer);

An HTML function for positioning the window in the interface 21 is also known.

window.setPosition (top, left)

The values “top” and “left” must be indicated in number of pixels or else by using a chain of characters ‘CENTER’.

The display and masking functions of a window are also known.

window.show(options);
window.hide( );

The options of the function show can be any combination of values ‘TITLE’, ‘CONTENT’, and ‘FOOTER’, separated by the character ‘|’.

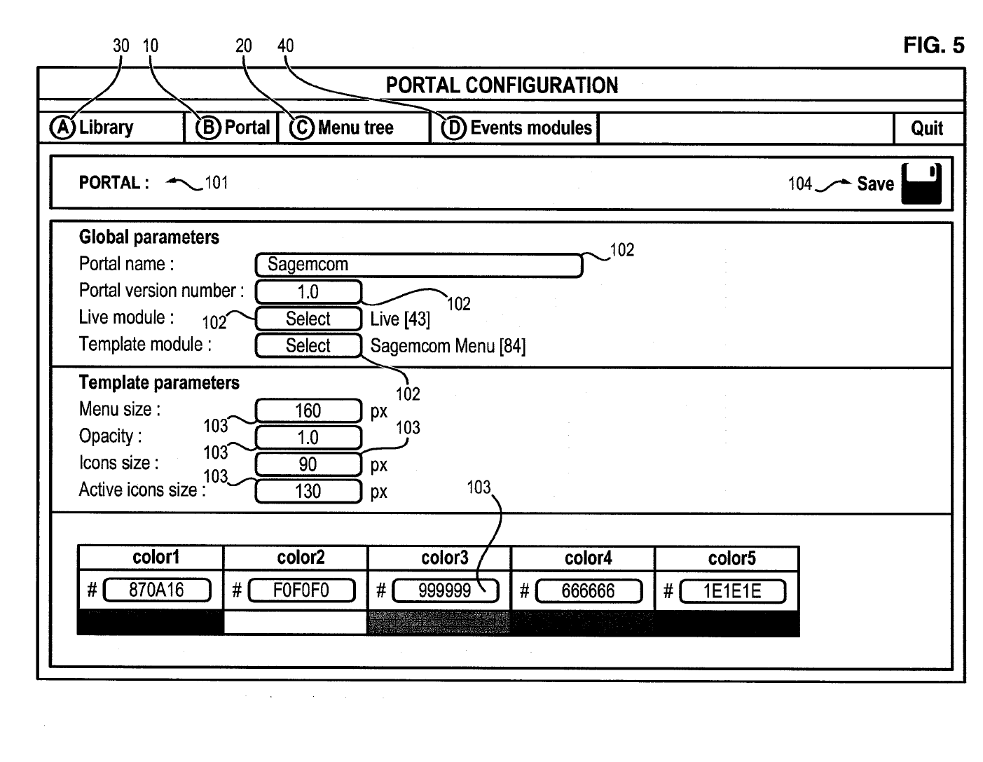

An example of HTML form letting the user point out an identifier of a portal project is shown in FIG. 5.

The form of the interface 21 comprises especially fields 101, 102, 103 and 104.

The field 101 is the current name of the portal.

The fields 102 modify or select
the name of the portal (“Portal name”),
the version number of the portal (“Portal version number”),
a module (“Live module”) executed at startup of the portal (field not informed in FIG. 5), as well as
the template of the module (“Template module”) to be applied.

The fields 103 configure the template to be applied, such as for example:
the size of the menu (“Menu size”),
the opacity of the menu (“Opacity”), and
the color (“color”) used.

The field 104 “Save” lets configurations be saved.

The information input in the fields 101 to 103 is therefore copied in the corresponding table 321 on the server 3.

Still during step S1, the interface 21 allows selection and organisation of the set E1 of modules 211 or 212 forming the web portal.

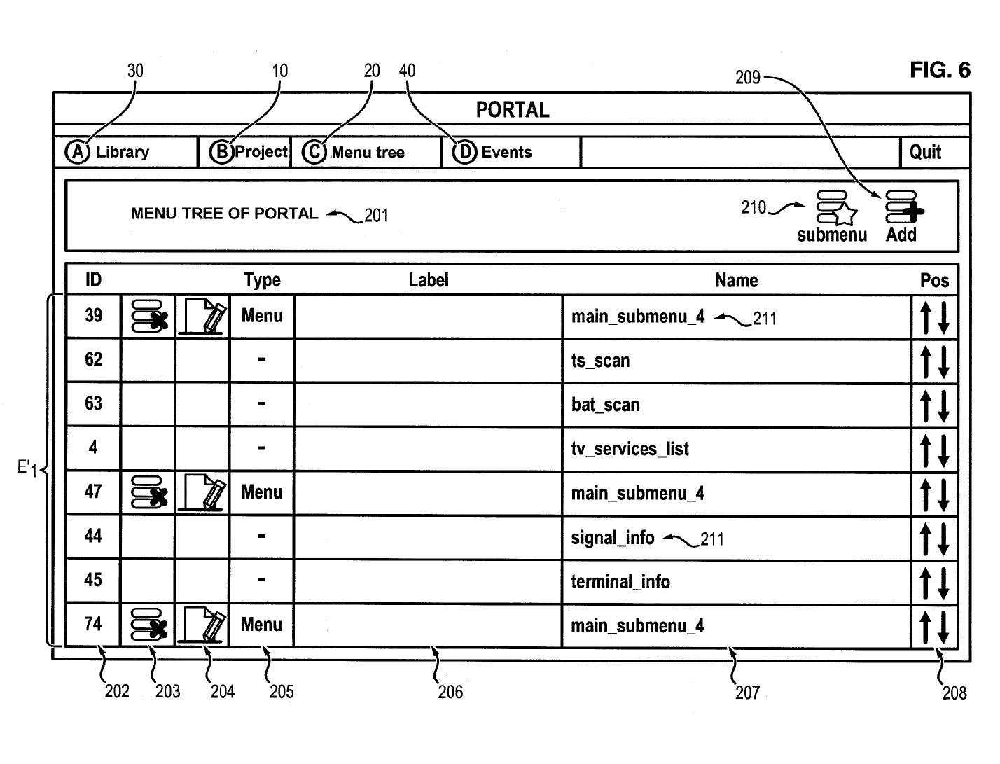

For this purpose, the interface 21 comprises an HTML form of a menu tree of the portal (“portal tree”), for example complying with that in FIG. 6.

It is possible for the user to obtain display of the form of the menu tree of the main menu of the portal, especially by selecting a tab 20 (selection by the mouse of the interface 21 or by pressure on the yellow key on the remote control of the interface 21 for example).

As is evident from FIG. 6, the HTML form comprises especially fields 201 to 210.

The field 201 is the title of the form, showing the menu tree of the portal in the form of a table comprising columns.

The table shows therefore a part E1′ of the set E1, said part E1′ comprising functionality modules 211 as wanted by the user.

The column 202 corresponds to a number for identifying each functionality module 211.

The column 203 deletes a module of the portal. This deletion is preferably definitive.

The column 205 shows the type of module: “menu” or “−”. It is recalled that a module cannot be executed via a module of “−” type, but only via a module of “menu” type.

The column 206 shows the name of the module as it will appear in the portal (“Label”).

The column 207 shows the name of the module in a library (“Library”).

The column 208 modifies the position of a module in the menu tree of the portal.

When the field 209 is selected in association with a module of “menu” type, the library, especially containing the functionality module 211 available for the user, appears on the interface 21.

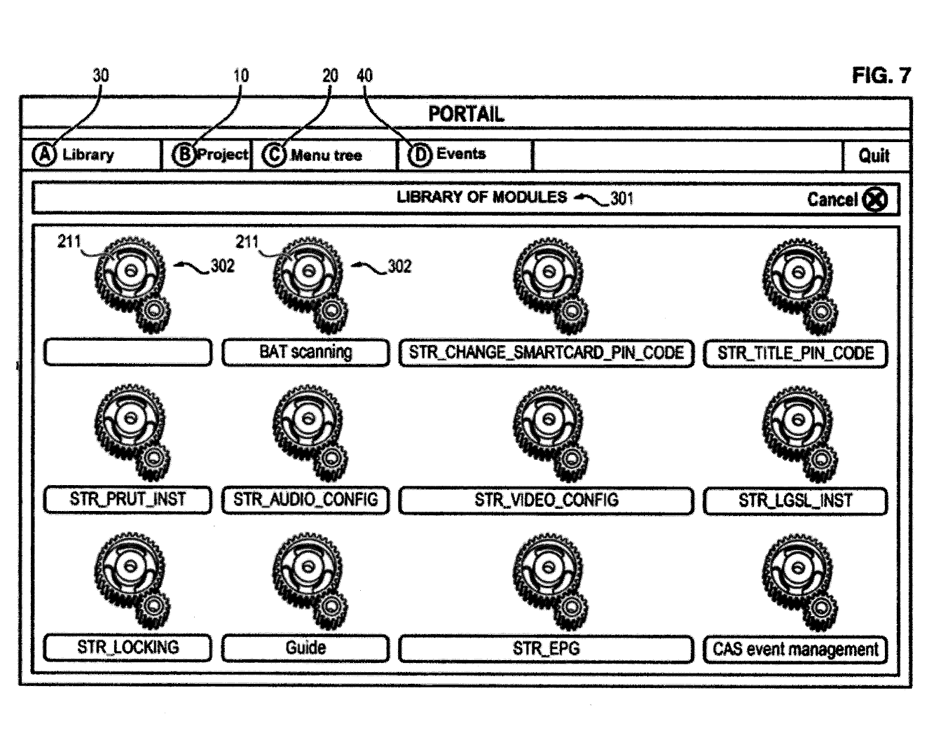

A possible example of HTML form of the interface 21 and representing the library, for the addition of a module 211 to a module of “menu” type is illustrated in FIG. 7.

As is evident from FIG. 7, the HTML form comprises fields 301 and 302.

The field 301 called the library and the fields 302 illustrate the modules 211 or 212 available for the user, in the form of icons.

The form of FIG. 7 adds to the part E1′ a preferred module 211 to said module of “menu” type by mouse click on the icon of the preferred module, for example.

Also, when the field 210 on the form of FIG. 6 is selected, it is possible to add a module of “menu” type to another module of “menu” type, to add a “sub-menu” in the menu tree of the portal.

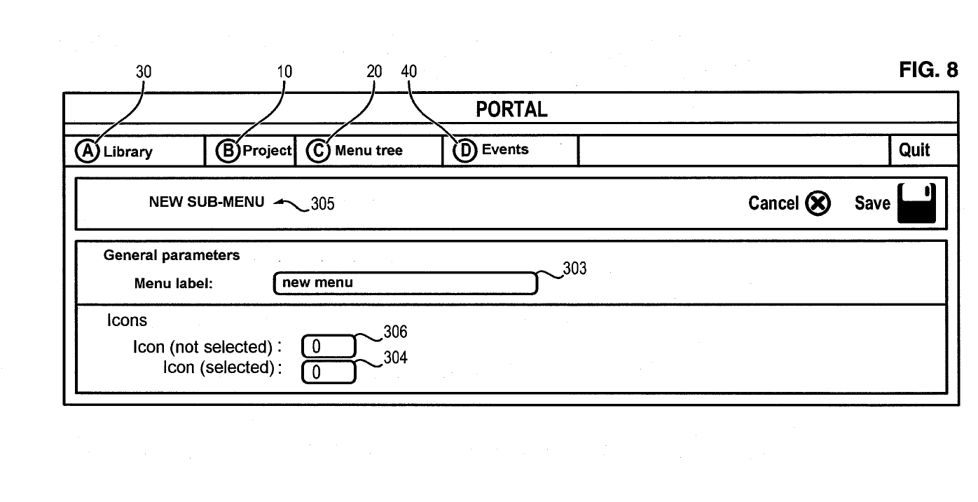

A possible example of HTML form of the interface 21 for addition of a sub-menu to a menu, and displaying after selection of the field 210, is shown in FIG. 8.

As is evident from FIG. 8, the HTML form especially comprises fields 303, 304 and 305.

The field 305 gives the current title of the new sub-menu.

The field 303 gives the name of the new sub-menu.

The fields 304 select an identifier number of associated icons.

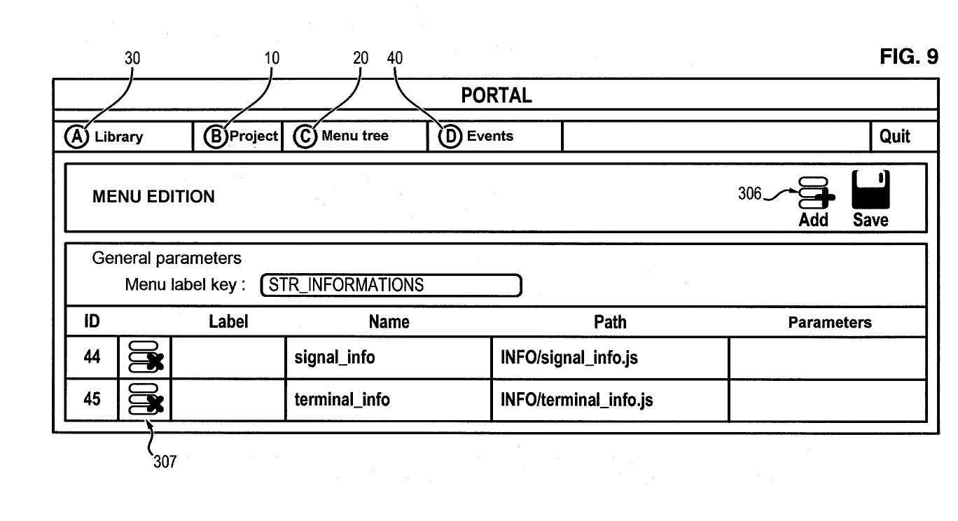

The column 204 of the table in FIG. 6 edits and modifies a sub-menu, while FIG. 9 shows a possible form of the interface 21, the form containing fields 306 and 307.

As shown in FIG. 9, the form edited by selection of the column 204 offers the same possibilities for modifications of the sub-menu as for a menu of the menu tree of the main menu (addition of modules by the field 306 and deletion of modules by the field 307).

The set E1 also comprises event-managing modules 212.

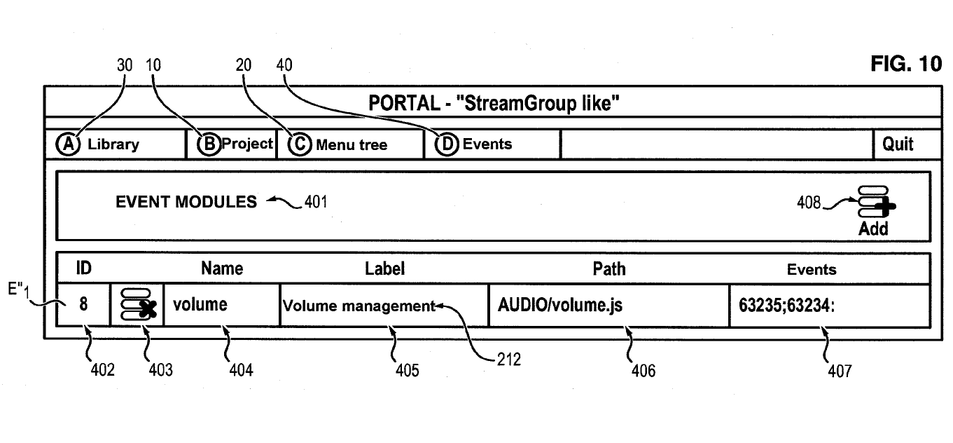

A possible example of HTML form of the interface 21 is illustrated in FIG. 10.

The form illustrates a part E1″ of the set E1, the part E1″ combining event-managing modules 212 in the form of a table.

This form is displayed for example when the tab 40 of the interface 21 is selected, said selection being made via the mouse or by the blue key on the remote control of the interface 21.

As is evident from FIG. 10, the HTML form comprises fields 401 to 408.

The field 401 is the title of the form.

The column 402 corresponds to a number identifying each module 212.

The column 403 deletes a module from the portal. This deletion is preferably definitive.

The column 404 shows the name of the module in the library.

The column 405 shows the name of the module as it will appear in the portal (“Label”).

The column 406 shows the path to a code 42 in Javascript format for example and associated to the module 212.

The column 407 shows the events managed by the module 212. In the example of FIG. 10, the portal includes only the “volume” module 212, which manages the support on the V+ and V− keys (events 63235 and 6234).

When the field 408 is selected, the library, containing especially management modules 212 available for the user, appears on the interface 21. The interface 21 adds to the set E1 a preferred module 212, as described earlier for a module 211.

During selection of a module 211 or 212 in the library of FIG. 7, the name of the module 211 or 212 corresponding is copied in the table 321 corresponding to the project on the server 3.

Once the user estimates that the set E1, comprising parts E1′ and E1″ and combining the modules 211 and 212, is complete, he signals to the processor by way of the interface 21 that this is the case. He can do this for example by way of a message on the interface 21.

During compilation step S2, the processor 22 of the computer 2 generates, from the set E1, a file E3 of instructions which can be run by the browser 11.

For this purpose, a form of the interface 21 allows the user to indicate to the processor 2 the identifier of the portal for which the file E3 must be generated.

An example of code which can be provided for the HTML form of the interface 21 is, for example:

<form name=“generatePortal” action=“main.php” method=“post”>
<input type=“hidden” name=“projectId” id=“projectId_generate”
value=“13”/>
</form>

Conventionally, the HTML form is defined with the tags <form> and </form>. The attribute “action” of the tag <form> specifies the page which will process the data provided in the form by the user: here this is the “main” page. The “method” attribute shows that the transmission method is the POST method, also known to the expert.

The processor 22 therefore sends a request to the 33 PHP module so that the latter executes the file “main.php” corresponding to the portal.

The distinction between different portal projects is made for example by specifying in argument, in the name of the file, the identifier of the preferred project.

In a first instance, classic Javascript files are loaded by the module 33.

Classic files are those files containing for example the constants, the objects and overall functions, the event management functions or the translation files.

A possible instruction for this loading is for example:

<script language=“JavaScript” src=“js/constant.js”></script>
. . .
<script language=“JavaScript”
src=“js/utils_userInfterface.js”><script>
<script language=“JavaScript” src=“main.js”></script>

Next comes loading by the module 33 of Javascript files containing the source codes 42 of the modules 211 or 212 utilised by the portal.

A possible instruction for this loading is for example:

<?php
for ($i=0; $i<sizeof($moduleList); $i++)
{
$reqModule = $database−>query(‘ SELECT modulePath
FROM scp_module
WHERE moduleId = \′′.$moduleList[$i].′\′′);
if($smodule = $reqModule−>fetch( ))
echo ′<script language=″JavaScript″
src=″′.$module[′modulePath′].′″></script>′;
$reqModule−>closeCursor( );
}
?>

PHP language is used by the module 33 of the server 3 to interpret the preceding PHP code and generate of the code which could be interpreted by the browser 11, such as for example XHTML, HTML, CSS or JavaScript, here preferably HTML and Javascript.

Next, the parameters of the portal are converted into Javascript variables by the module 33.

A possible instruction for this conversion is for example:

g_projectName = <?php echo ‘“‘. $projectName.’”’; ?>;
. . .
g_portalLanguage = <?php echo ‘“‘.$defaultLanguage.’”’;?>;

A table (g_iconTable) containing the access paths to the icons is created by the module 33.

A possible instruction for this creation is for example:

<?php
for ($i=0; $i<sizeof($iconIdList); $i++)
{
$request = $database−>query(‘SELECT iconPath
FROM scp_icons
WHERE iconId = \‘‘.$iconIdList[$i].’\’’);
if($icon = $request−>fetch( ))
echo ‘g_iconTable.push(new Array(“‘.$iconIdList[$i].’”,“‘.
$icon[‘iconPath’].’”)) ;’;
$request−>closeCursor( );
}
?>

Another table (g_moduleTable), containing the Javascript objects corresponding to the modules included in the portal by way of the set E1 is created by the module 33, and each module builder is called.

A possible instruction for this creation is for example:

<?php
for ($i=0; $i<sizeof($moduleList); $i++)
{
$reqModule = $database−>query(‘SELECT moduleLabel, moduleName,
modulePath,
moduleParam
FROM scp_module
WHERE moduleId = \‘‘.$moduleList[$i].’\’’);
if($module = $reqModule−>fetch( ))
{
echo ‘g_moduleTable.push(new
window[“‘.$module[‘moduleName’].’”](“‘.$moduleList[$i].’”,“‘.
$module[‘moduleLabel’].’”,“‘.
$module[‘moduleParam’].’”)) ;’;
}
$reqModule−>closeCursor( );
}
?>

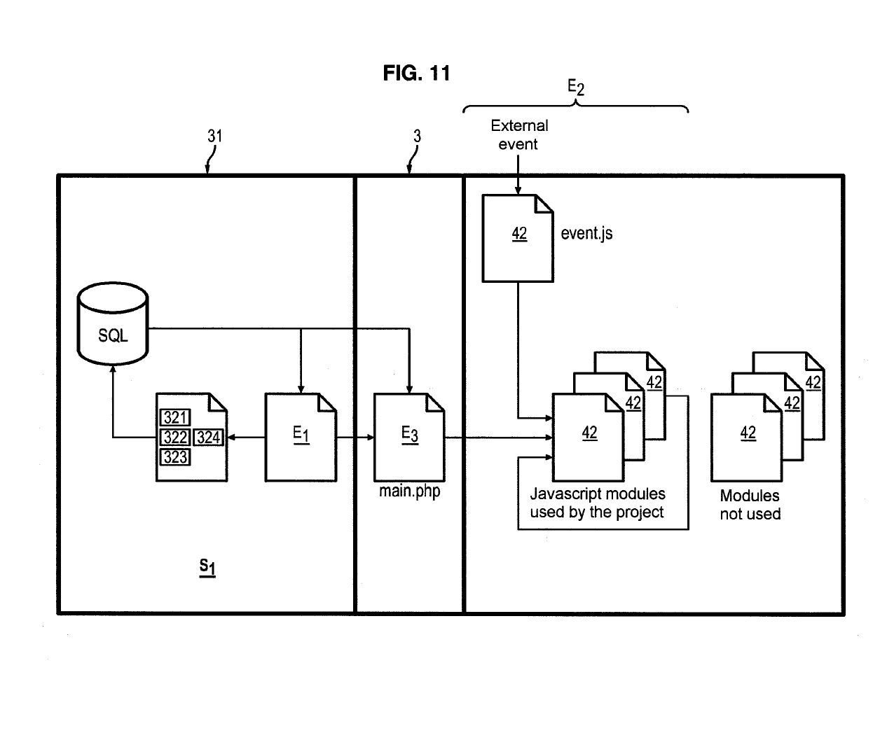

Therefore, as shown by FIG. 11, from the set E1, and the files comprising the Javascript or HTML codes 42 corresponding to the modules 211 and 212 of the set E1, the processor generates the file E3. The file E3 contains only web-oriented code, using known W3C technologies (for example HTML, JavaScript, CSS, XML, XSLT, CGI . . . ). The main file php can be renamed main.html, for example.

The group of codes 42 utilised by the portal is called E2.

It is clear that during steps S1 and S2 described hereinabove, a link is required between the computer 2 and the server 3.

During downloading step S4, the processor 22 downloads
the file E3 of instructions, and
the group E2 of codes 42 associated to the modules 211 and 212 of the set E1
   from the server 3 on the device 1, as shown in FIG. 1. This supposes therefore a link between the server 3 and the device 1.

On completion of step S4, the connection between the server 3 and the device 1 is broken, and the device 1 can take normal operation. The link between the computer 2 and the server 3 can also be broken.

To take its normal operation, the browser 11 of the device 1 executes a function, for example called load_main( ) and contained in the file main.js, and which:
launches a startup module of the portal (referenced by the startingModuleId field in the table 321), and
creates a key press K event handler (a K event is a relaxing of a key of a computer keypad or a set top box remote control for example).

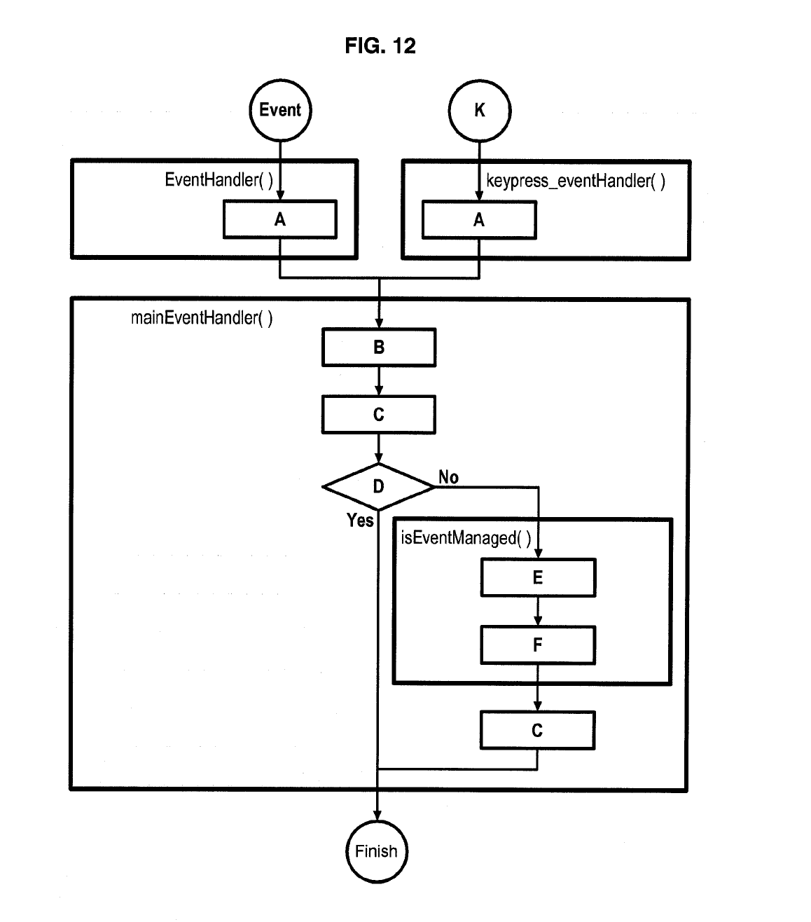

In fact, as shown by FIG. 12, there are two clear types of events, specifically:
key press K events, and whereof the entry point is a function for example called keypress_eventHandler( ) and
Event events, appeared and detected by the browser, whereof the entry point is the function called EventHandler( ) for example.

The created key press K event handler and/or the Event event handler call the function for example called MainEventHandler( ).

A possible instruction for this call is for example:

document.addEventListener (‘keyup’,
function(e){MainEventHandler(e);}, false);

During an Event or K event, each event is converted into an object of event object type, with several parameters in the form of a table, during step A.

The event objects are managed by the function mainEventHandler( ) during steps B, C, D, E or F.

As shown in FIG. 11, the file E3 of instructions in fact comprises instructions which send to the code 42, for example called event.js, instructions according to which the events are managed by a stack of event-managing modules 212 or functionality modules 211 if the latter are active.

Accordingly, during a step B the event object is transmitted to the active module located on the top of a stack of modules.

During a step C, the object event is taken into account by said module.

The mainEventHandler( ) function determines in D if the object event is managed by said module.

If the response is yes, the object is processed and this is the end of the mainEventHandler( ) function.

If the response is no, the mainEventHandler( ) function determines in E if this same object event must trigger one (or more) modules from a table g_eventTable. During a step F, in the case of several modules to be triggered, one parameter e specifies the associated priority.

Next comes step C, already described.

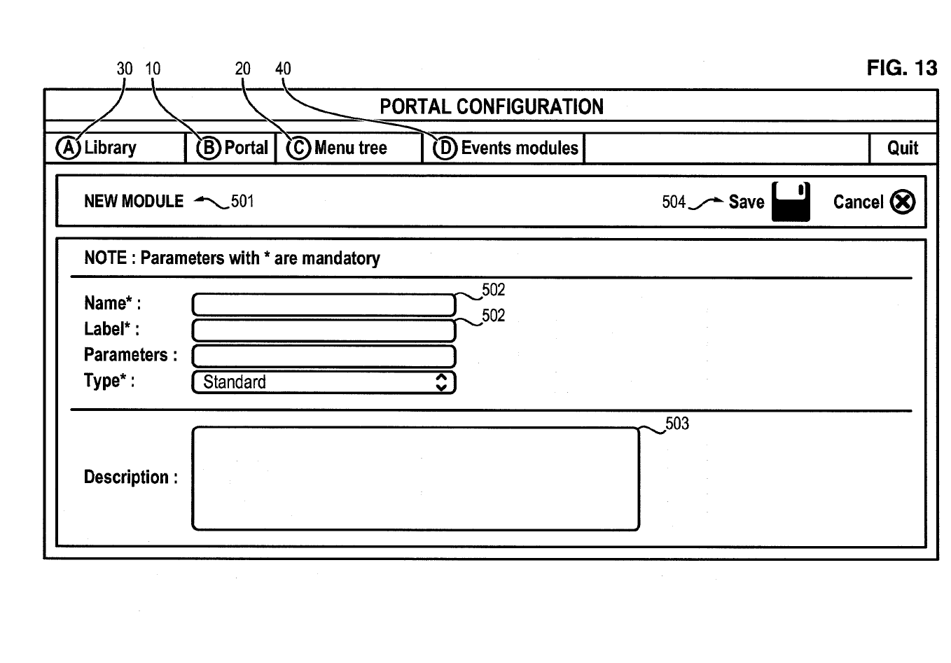

As shown in FIG. 13, the interface 21 comprises an HTML form for adding to the library a new module.

Highly preferably, all the modules 211 or 212 have the same standard structure with especially:
a builder,
an identifier (also called “id”),
a name (also called “Label”), and
a type of module, specifying the “start” function for the modules 211 or the method of event management for the modules 212.

The form of FIG. 13 comprises fields 501, 502, 503 and 504.

The fields 502 comprise mandatory fields, especially for name (Name), name of the module as it will appear in the portal (“Label”), and the type of module. According to the type of module selected, more or fewer additional options can appear.

The field 503 inputs a description of the module, for the attention of the user.

The field 504 saves the input.

During saving, a new table 322 is created on the server 3.

Similarly, previously or afterwards, a corresponding code 42 is created on the server 3.

The codes 42 of the modules are coded in HTML but highly preferably in Javascript, for example in the form:

function module_name(id, label, parameter)
{
// variables publiques
this.id = id;
this.label = label;
// variables privées
var internalVar = ‘toto’;
// constructeur
. . .
// fonction de lancement du module
this.start = function(caller)
{
};
// gestionnaire d'évenement du module
this.eventHandler - function(event)
{
};
// fonction publique supplémentaire
this.externalFunction = function(event)
{
};
// fonction privée supplémentaire
var internalFunction = function(argument)
{
};
}

The computer 2 can be incorporated into all or part of the device 1.

The process can also comprise an optional test step S3 of the file E3 of instructions prior to the downloading step S4.

The test step S3 relates to the modules 211 and 212, available in the library common to all the portal projects, such that the test step serves for the later evolutions of the portal or for another portal also.

Similarly, the correction of bugs on the modules 211 or 212 serves for the later evolutions of the portal or for another portal also.

The invention also relates to a computer program product comprising instructions which, once loaded onto memory of a computer, execute a process according to the invention. The product can be on any computer medium, such as for example a memory or a CD-Rom.

1. A process for development of a web portal, the web portal being run locally by a browser (11) of a device (1), the process being characterised in that it comprises
a configuration step (S1) of the portal, according to which an interface (21) of a computer (2) allows selection and organisation of a set (E1) of functionality modules (211) and/or event-managing modules (212) forming the web portal, a code (42) stored on a server (3) being associated to each of said modules (211, 212);
a compilation step (S2), according to which a processor (22) of the computer (2) generates from the set (E1) a file (E3) of instructions which can be used by the browser (11); and
a downloading step (S4), according to which the processor (22) downloads the file (E3) of instructions and a group (E2) of codes (42) associated to the modules (211, 212) on the device (1).

2. The process according to claim 1, wherein the selection of functionality modules (211) and/or event-managing modules (212) is made from a library of modules (211, 212).

3. The process according to any one of claim 1 or 2, wherein the processor generates (S2) the file (E3) of instructions by means of the server (3) comprising a PHP module (33), the file (E° 3) being in web-oriented format using W3C technologies, preferably HTML, JavaScript, CSS, XML, XSLT or CGI.

4. The process according to any one of claims 1 to 3, wherein each module (211, 212) is constructed under the same standard structure.

5. The process according to any one of claims 1 to 4, wherein the file (E3) of instructions comprises instructions according to which the events are managed by a stack of event-managing modules (212) or functionality modules (211).

6. The process according to any one of claims 1 to 5, further comprising a test step (S3) of the file (E3) of instructions before the downloading step (S4).

7. A system for development of a web portal, comprising
a device (1) comprising a browser (11) locally using the web portal
a computer (2) comprising an interface (21) and a processor (22), and
a server (3) comprising a database (31),
the system being characterised in that
the interface (21) is configured to allow selection and organisation of a set (E1) of functionality modules (211) and/or event-managing modules (212) forming the web portal;
the processor (22) is configured to generate, from the set (E1), a file (E3) of instructions which can be run by the browser (11); and
the processor (22) is configured to download the file (E3) of instructions and a group (E2) of codes (42) associated to the modules (211, 212) on the device (1), from a server (3).

8. The system according to claim 7, wherein the computer (2) is in all or part in the device (1).

9. The system according to any one of claim 7 or 8, wherein the device (1) is any onboard device having a browser, preferably a set top box.

10. A computer program product comprising a set of instructions which, once loaded on a computer, executes a process according to any one of claims 1 to 6.
